(19) United States
(12) Patent Application Publication
(10) Pub. No.: US 2026/0145261 A1
(43) Pub. Date: May 28, 2026

(54) SONOTRODES FOR ULTRASONICALLY WELDING A CONDUCTIVE PIN TO A WORKPIECE, ULTRASONIC WELDING SYSTEMS, AND RELATED METHODS

(71) Applicant: Kulicke and Soffa Industries, Inc., Fort Washington, PA (US)

(72) Inventors: Henri Seppaenen, Irvine, CA (US); Barton David Adkins, Oceanside, CA (US)

(73) Assignee: Kulicke and Soffa Industries, Inc., Fort Washington, PA (US)

(21) Appl. No.: 19/399,914

(22) Filed: Nov. 25, 2025

Related U.S. Application Data
(60) Provisional application No. 63/725,093, filed on Nov. 26, 2024.

(51) Int. Cl. B23K 20/10; B23K 37/053; B23K 101/38

(52) U.S. Cl. CPC B23K 20/106; B23K 37/053; B23K 2101/38

(57) ABSTRACT

A sonotrode for ultrasonically welding a conductive pin to a workpiece is provided. The sonotrode includes a body portion configured to be coupled to an ultrasonic converter. The body portion terminates at a tip portion, the tip portion defining a mating feature configured to mate with a corresponding mating feature of a base portion of the conductive pin. The conductive pin is oriented in a predetermined configuration by mating of the mating feature with the corresponding mating feature of the base portion.

### CROSS-REFERENCE TO RELATED APPLICATION

This application claims the benefit of U.S. Provisional Application No. 63/725,093, filed Nov. 26, 2024, the content of which is incorporated herein by reference.

### FIELD

The invention relates to ultrasonic welding, and more particularly, to improved sonotrodes for use in ultrasonic welding systems, such as ultrasonic welding systems for conductive pin welding.

### BACKGROUND

Ultrasonic welding is a technology used for joining conductive components. Ultrasonic welding may use an ultrasonic converter (e.g., carrying a sonotrode) for converting electrical energy into mechanical movement/scrub (e.g., linear movement/scrub, torsional movement/scrub, etc.). U.S. Pat. Nos. 10,882,134 and 11,364,565 (each entitled “ULTRASONIC WELDING SYSTEMS AND METHODS OF USING THE SAME”), assigned to Kulicke and Soffa Industries, Inc., relate to improvements in ultrasonic welding technology, and are incorporated herein by reference in their entirety.

A specific application of ultrasonic welding technology relates to ultrasonic pin welding (where such pins are conventionally soldered and/or press fit into power modules). U.S. Pat. No. 11,285,561 (entitled “ULTRASONIC WELDING SYSTEMS AND METHODS OF USING THE SAME”), U.S. Pat. No. 11,504,800 (entitled “ULTRASONIC WELDING SYSTEMS AND METHODS OF USING THE SAME”), U.S. Pat. No. 11,958,124 (entitled “ULTRASONIC WELDING SYSTEMS AND METHODS OF USING THE SAME”), U.S. Pat. No. 11,850,676 (entitled “ULTRASONIC WELDING SYSTEMS, METHODS OF USING THE SAME, AND RELATED WORKPIECES INCLUDING WELDED CONDUCTIVE PINS”), U.S. Pat. No. 12,070,814 (entitled “ULTRASONIC WELDING SYSTEMS, METHODS OF USING THE SAME, AND RELATED WORKPIECES INCLUDING WELDED CONDUCTIVE PINS”), U.S. Pat. No. 12,377,489 (entitled “ULTRASONIC WELDING SYSTEMS, METHODS OF USING THE SAME, AND RELATED WORKPIECES INCLUDING WELDED CONDUCTIVE PINS”), U.S. Pat. No. 12,370,620 (entitled “ULTRASONIC WELDING SYSTEMS FOR CONDUCTIVE PINS, AND RELATED METHODS”), U.S. Patent Application Publication No. 2025/0332654 (entitled “ULTRASONIC WELDING SYSTEMS FOR CONDUCTIVE PINS, AND RELATED METHODS”), U.S. Patent Application Publication No. 2025/0187103 (entitled “CONDUCTIVE PINS, POWER MODULES, ULTRASONIC WELDING SYSTEMS, AND METHODS OF USING THE SAME”), International Patent Application Publication No. WO 2024/220203 (entitled “ULTRASONIC WELDING SYSTEMS, SONOTRODES AND CONDUCTIVE PINS FOR SUCH SYSTEMS, AND RELATED METHODS AND WORKPIECES”), and U.S. Patent Application Publication No. 2025/0289074 (“ULTRASONIC WELDING SYSTEMS, AND SONOTRODES FOR ULTRASONIC WELDING SYSTEMS”), each assigned to Kulicke and Soffa Industries, Inc., relate to improvements in ultrasonic welding technology related to conductive pins, and are also incorporated by reference in their entirety.

In practice, a sonotrode may be used to pick up a conductive pin prior to ultrasonic welding of the conductive pin to a workpiece. During pick up and/or ultrasonic welding, a conductive pin may be misaligned and/or misoriented with respect to the sonotrode. Thus, it would be desirable to provide improved sonotrodes, and ultrasonic welding systems including such sonotrodes, configured for use in connection with ultrasonic pin welding.

### SUMMARY

According to an exemplary embodiment of the invention, a sonotrode for ultrasonically welding a conductive pin to a workpiece is provided. The sonotrode includes a body portion configured to be coupled to an ultrasonic converter. The body portion terminates at a tip portion, the tip portion defining a mating feature configured to mate with a corresponding mating feature of a base portion of the conductive pin. The conductive pin is oriented in a predetermined configuration by mating of the mating feature defined by the tip portion with the corresponding mating feature of the base portion.

According to another exemplary embodiment of the invention, an ultrasonic welding system is provided. The ultrasonic welding system includes a support structure configured for supporting a workpiece and a weld head assembly. The weld head assembly includes an ultrasonic converter, and a sonotrode carried by the ultrasonic converter. The sonotrode includes a tip portion, the tip portion defining a mating feature configured to mate with a corresponding mating feature of a base portion of the conductive pin. The conductive pin is oriented in a predetermined configuration by mating of the mating feature defined by the tip portion with the corresponding mating feature of the base portion.

According to other embodiments of the invention, the sonotrode and/or the ultrasonic welding system recited in the immediately two preceding paragraphs may have any one or more of the following features: the mating feature defined by the tip portion includes an aperture configured to mate with a shape of the corresponding mating feature of the base portion; the conductive pin defines a hole at a location along its length, the predetermined configuration being related to an orientation of the hole; the conductive pin is an “L” shaped conductive pin, the predetermined configuration being related to an orientation of the “L” shaped conductive pin; the conductive pin is a power terminal configured for ultrasonic welding in a power module; the sonotrode is configured to weld the conductive pin to a workpiece using linear motion; the mating feature defined by the tip portion includes a chamfered portion configured to guide the conductive pin to an aligned position with respect to the sonotrode; and the sonotrode is configured to weld the conductive pin to a workpiece using torsional motion.

According to another exemplary embodiment of the invention, a sonotrode for ultrasonically welding a conductive pin to a workpiece is provided. The sonotrode includes a body portion configured to be coupled to an ultrasonic converter. The body portion terminates at a tip portion. The tip portion is configured to receive the conductive pin. The sonotrode also includes an alignment mechanism configured to align the conductive pin within an aperture of the sonotrode.

According to another exemplary embodiment of the invention, an ultrasonic welding system is provided. The ultrasonic welding system includes a support structure configured for supporting a workpiece. The ultrasonic welding system also includes a weld head assembly including an ultrasonic converter. The ultrasonic welding system also includes a sonotrode carried by the ultrasonic converter. The sonotrode includes a tip portion. The tip portion is configured to receive a conductive pin. The sonotrode also includes an alignment mechanism configured to align the conductive pin within an aperture of the sonotrode.

According to other embodiments of the invention, the sonotrode and/or the ultrasonic welding system recited in the immediately two preceding paragraphs may have any one or more of the following features: the alignment mechanism includes a first alignment tool for aligning the conductive pin; the alignment mechanism includes a second alignment tool for aligning the conductive pin, the first alignment tool is disposed adjacent a first lateral aperture of the sonotrode, the second alignment tool is disposed adjacent a second lateral aperture of the sonotrode; the first alignment tool and second alignment tool are configured to be provided with ultrasonic energy during a pin alignment operation; the first alignment tool and second alignment tool are configured to vibrate during a pin alignment operation; the first alignment tool and second alignment tool are spring based alignment tools; the alignment mechanism is an alignment tool disposed within the aperture of the sonotrode, the alignment tool defining an alignment aperture configured to receive an upper tip of the conductive pin; and the conductive pin defines a hole at a location along its length, the alignment mechanism aligning the conductive pin within the aperture through engagement with the hole.

According to another exemplary embodiment of the invention, a method of operating an ultrasonic welding system is provided. The method includes the steps of: (a) providing a conductive pin to a sonotrode of the ultrasonic welding system, the sonotrode including a body portion terminating at a tip portion, the tip portion defining a mating feature configured to mate with a corresponding mating feature of a base portion of the conductive pin; and (b) orienting the conductive pin in a predetermined configuration with respect to the sonotrode by mating of the mating feature defined by the tip portion with the corresponding mating feature of the base portion.

According to other embodiments of the invention, the method of operating an ultrasonic welding system recited in the immediately preceding paragraph may have any one or more of the following features: step (a) includes picking up the conductive pin using the sonotrode; the sonotrode picks up the conductive pin using a vacuum source; step (b) includes using a vacuum source coupled to the sonotrode, wherein the vacuum source assists in orienting the conductive pin in the predetermined configuration; further including a step of (c) ultrasonically welding the conductive pin to a workpiece after step (b); step (c) includes using torsional welding for ultrasonically welding the conductive pin to the workpiece; wherein step (c) includes using linear welding for ultrasonically welding the conductive pin to the workpiece; the mating feature defined by the tip portion includes an aperture configured to mate with a shape of the corresponding mating feature of the base portion; the conductive pin defines a hole along its length, the predetermined configuration being related to an orientation of the hole; the conductive pin is an “L” shaped conductive pin, the predetermined configuration being related to an orientation of the “L” shaped conductive pin; the conductive pin is a power terminal configured for ultrasonic welding in a power module; and the mating feature defined by the tip portion includes a chamfered portion configured to guide the conductive pin to an aligned position with respect to the sonotrode.

According to another exemplary embodiment of the invention, a method of operating an ultrasonic welding system is provided. The method includes the steps of: (a) providing a conductive pin to a sonotrode of the ultrasonic welding system, the sonotrode including a body portion terminating at a tip portion, the tip portion receiving the conductive pin; and (b) aligning the conductive pin within an aperture of the sonotrode at the tip portion using an alignment mechanism.

According to other embodiments of the invention, the method of operating an ultrasonic welding system recited in the immediately preceding paragraph may have any one or more of the following features: step (a) includes picking up the conductive pin using the sonotrode; the sonotrode picks up the conductive pin using a vacuum source; further including a step of (c) ultrasonically welding the conductive pin to a workpiece after step (b); step (c) includes using torsional welding for ultrasonically welding the conductive pin to the workpiece; wherein step (c) includes using linear welding for ultrasonically welding the conductive pin to the workpiece; the alignment mechanism includes a first alignment tool for aligning the conductive pin; the alignment mechanism includes a second alignment tool for aligning the conductive pin, the first alignment tool is disposed adjacent a first lateral aperture of the sonotrode, the second alignment tool is disposed adjacent a second lateral aperture of the sonotrode; the first alignment tool and second alignment tool are configured to be provided with ultrasonic energy during a pin alignment operation; the first alignment tool and second alignment tool are configured to vibrate during a pin alignment operation; the first alignment tool and second alignment tool are spring based alignment tools; the alignment mechanism is an alignment tool disposed within the aperture of the sonotrode, the alignment tool defining an alignment aperture configured to receive an upper tip of the conductive pin; the conductive pin defines a hole along its length, and step (b) includes aligning the conductive pin within the aperture of the sonotrode such that the hole is arranged in a predetermined configuration; and the conductive pin is an “L” shaped conductive pin, wherein step (b) includes aligning the conductive pin within the aperture such that the “L” shaped conductive pin is arranged in a predetermined configuration.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a block diagram of an ultrasonic welding system in accordance with various exemplary embodiments of the invention;

FIGS. 2A-2F are cross-sectional side and top views of a sonotrode including an alignment mechanism, and a conductive pin, in accordance with an exemplary embodiment of the invention;

FIGS. 3A-3B are cross-sectional side views of another sonotrode including an alignment mechanism, and the conductive pin of FIGS. 2A-2F, in accordance with another exemplary embodiment of the invention;

FIG. 4 is a cross-sectional side view of the sonotrode of FIGS. 2A-2F, and the conductive pin of FIGS. 2A-2F, in accordance with another exemplary embodiment of the invention;

FIG. 5A is a cross-sectional side view of another sonotrode including an alignment mechanism, and the conductive pin of FIGS. 2A-2F, in accordance with another exemplary embodiment of the invention;

FIG. 5B is a bottom view of the sonotrode of FIG. 5A;

FIG. 5C is a top view of the conductive pin of FIG. 5A in connection with a portion of the sonotrode of FIG. 5A;

FIG. 6A is a cross-sectional side view of another sonotrode, and another conductive pin, in accordance with another exemplary embodiment of the invention;

FIG. 6B is a bottom view of the sonotrode of FIG. 6A;

FIG. 6C is a top view of the conductive pin of FIG. 6A;

FIG. 7A is a cross-sectional side view of another sonotrode, and another conductive pin, in accordance with another exemplary embodiment of the invention;

FIG. 7B is a bottom view of the sonotrode of FIG. 7A;

FIG. 7C is a top view of the conductive pin of FIG. 7A;

FIGS. 8A-8B are cross-sectional side views of another sonotrode, and another conductive pin, in accordance with another exemplary embodiment of the invention;

FIGS. 8C-8D are top views of the conductive pin of FIGS. 8A-8B;

FIG. 8E is a bottom view of the sonotrode of FIGS. 8A-8B;

FIGS. 9A-9B are cross-sectional side views of another sonotrode, and another conductive pin, in accordance with another exemplary embodiment of the invention;

FIGS. 9C-9D are top views of the conductive pin of FIGS. 9A-9B;

FIG. 9E is a bottom view of the sonotrode of FIGS. 9A-9B;

FIG. 10A is a cross-sectional side view of another sonotrode, and another conductive pin, in accordance with another exemplary embodiment of the invention;

FIG. 10B is a bottom view of the sonotrode of FIG. 10A;

FIG. 10C is a top view of the conductive pin of FIG. 10A; and

FIGS. 11-12 are flow diagrams of various methods of operating an ultrasonic welding system in accordance with various exemplary embodiments of the invention.

### DETAILED DESCRIPTION

Certain conductive pins are desirably welded to a workpiece in a predetermined configuration. For example, conductive pins defining a “hole” along their length (sometimes referred to as “fisheye” pins) are sometimes welded to a workpiece. Such fisheye pins may be used for proper soldering setup after a power module is assembled. Such fisheye pins may be press fit into a feature on a PCB board. Thus, the configuration of the conductive pin when welded to a workpiece is important.

In the case of fisheye pins, and/or other conductive pins where the orientation of the conductive pin (e.g., a “directional” conductive pin) is relevant, certain embodiments of the present invention provide sonotrodes that properly orient/align the conductive pins during (and/or after) pick up of the conductive pin by the sonotrode. Accordingly, the orientation, alignment, and/or directionality (e.g., in an X-Y plane of an ultrasonic welding system) of the conductive pin can be provided when ultrasonically welding the conductive pin to a workpiece.

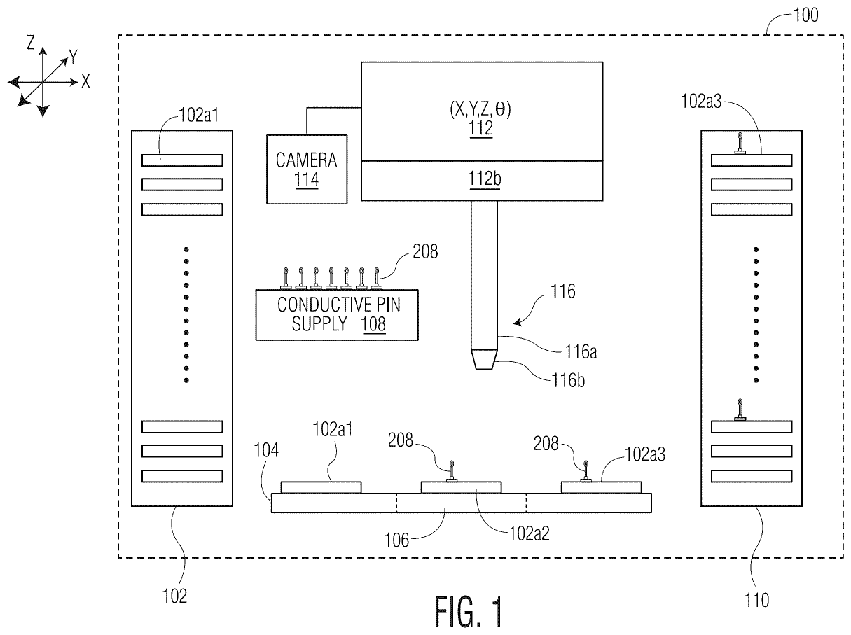

Referring now to the drawings, FIG. 1 illustrates an ultrasonic welding system 100. Ultrasonic welding system 100 includes an input workpiece supply 102 for providing a workpiece 102a1, where input workpiece supply 102 may be configured to carry a plurality of workpieces 102a1 (e.g., input workpiece supply 102 may be a carrier such as a magazine handler for carrying a plurality of workpieces 102a1, or other supply structures suitable for the application specific workpiece, etc.). Exemplary workpieces 102a1 carried by input workpiece supply 102 include power modules, components of power modules, lead frames, battery modules, etc. Workpieces 102a1 are provided (by any desired transport assembly which may be included in a material handling system 104, such as a gripper assembly) from input workpiece supply 102 to material handling system 104. Material handling system 104 moves workpiece 102a1 (e.g., using a conveyor assembly, using a gripper assembly, etc.) from input workpiece supply 102 to a support structure 106. Support structure 106 supports the workpiece (e.g., workpiece 102a1, a clamped workpiece 102a2, etc.) during a welding operation. After the welding operation (described below with respect to a weld head assembly 112), a now welded workpiece 102a3 is moved (e.g., using a conveyor assembly, using a gripper assembly, etc.) from a portion of material handling system 104 downstream of support structure 106, to an output workpiece supply 110. Output workpiece supply 110 is configured to receive welded workpieces 102a3 after processing by weld head assembly 112. Output workpiece supply 110 may be a carrier such as a magazine handler for carrying a plurality of welded workpieces 102a3, or another supply structure suitable for the application specific workpiece.

Ultrasonic welding system 100 includes weld head assembly 112. Weld head assembly 112 includes an ultrasonic converter 112b carrying a sonotrode 116 (e.g., sonotrode 216, sonotrode 216′, sonotrode 516, sonotrode 616, sonotrode 716, sonotrode 816, sonotrode 916, sonotrode 1016), and is moveable along a plurality of substantially horizontal axes (e.g., X-axis, Y-axis, etc.). Sonotrode 116 includes a body portion 116a terminating at a tip portion 116b (e.g., tip portion 216b, tip portion 516b, tip portion 616b, tip portion 716b, tip portion 816b, tip portion 916b, tip portion 1016b).

In the example illustrated in FIG. 1, weld head assembly 112 is configured to move along the X-axis and the Y-axis of ultrasonic welding system 100. In the example shown in FIG. 1, weld head assembly 112 is also configured to move along the Z-axis of ultrasonic welding system 100, and about a theta axis (Ø-axis) of ultrasonic welding system 100. Not all of these motion axes are required in each application. Using the motion axes of weld head assembly 112, sonotrode 116 is able to be moved into proper welding positions with respect to clamped workpiece 102a2 (clamps not illustrated). A camera 114 of ultrasonic welding system 100 is also provided (where camera may optionally be carried by weld head assembly 112, or may be carried by another part of ultrasonic welding system 100) for imaging operations related to the alignment between sonotrode 116 and clamped workpiece 102a2, the alignment of the components of clamped workpiece 102a2 in itself, optical inspection of the welds after welding operation, etc.

Various types of workpieces may be welded using ultrasonic welding system 100 (or other systems within the scope of the invention). Exemplary workpieces include a power module, a lead frame, and a battery module.

Various types of ultrasonic motion may be imparted on a conductor (e.g., a conductive pin, a signal connector, a conductive terminal, a power terminal, etc.) in accordance with the invention. For example, the sonotrode may be configured to weld a conductor to a workpiece using at least one of linear ultrasonic motion and torsional ultrasonic motion.

Certain of those workpieces are configured to receive a conductive pin. As used herein, the term “conductive pin” is a conductive structure intended to be welded to a workpiece. The conductive pin may have a free end (after being welded to a workpiece), and a body portion of the conductive pin may extend substantially vertically from a “welded” end to the free end. The cross section of the conductive pin may be round, square, rectangular, or have any desired cross section. The conductive pins described herein may be an “L-shaped” pin, a “fisheye” pin, among others. The term conductive pin shall also be construed to include conductive receptacles or sleeves (e.g., a tubular shape), where the conductive receptacle/sleeve is ultrasonically welded to a workpiece, and configured to receive another conductive element. In certain embodiments, the conductive pin may be a power terminal configured for ultrasonic welding in a power module.

In accordance with certain exemplary embodiments of the invention, ultrasonic welding system 100 includes a conductive pin supply 108 configured to provide a plurality of conductive pins 208 (e.g., although conductive pins 208 are shown, conductive pin supply 108 may include any pins within the scope of the invention such as conductive pin 608, conductive pin 708, conductive pin 808, conductive pin 908, and conductive pin 1008) for welding using sonotrode 116. Exemplary configurations for conductive pin supply include: a grid arrangement (including columns and rows of conductive pins, oriented in such a way for ease of pick up), a bowl feeder, a hopper, a spool, etc. Alternative configurations are contemplated. The conductive pin supply 108 may be configured to operate with a buffer system so that pins are fed through a staging area, ready to be picked up for welding.

Ultrasonic welding system 100, including conductive pin supply 108 and sonotrode 116, may take various forms. More specifically, different configurations of conductive pin supply 108, different configurations of sonotrode 116, etc. are contemplated. Exemplary configurations are illustrated and described herein.

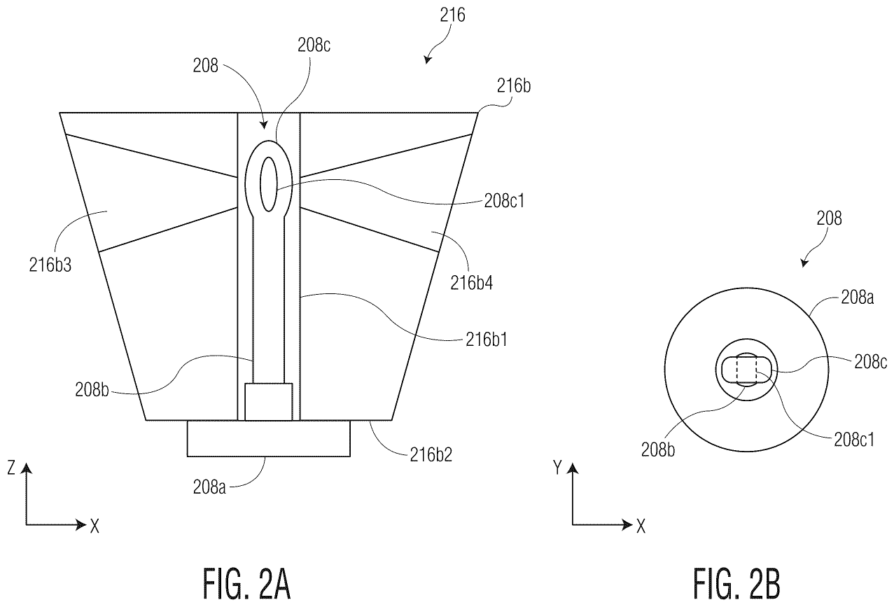

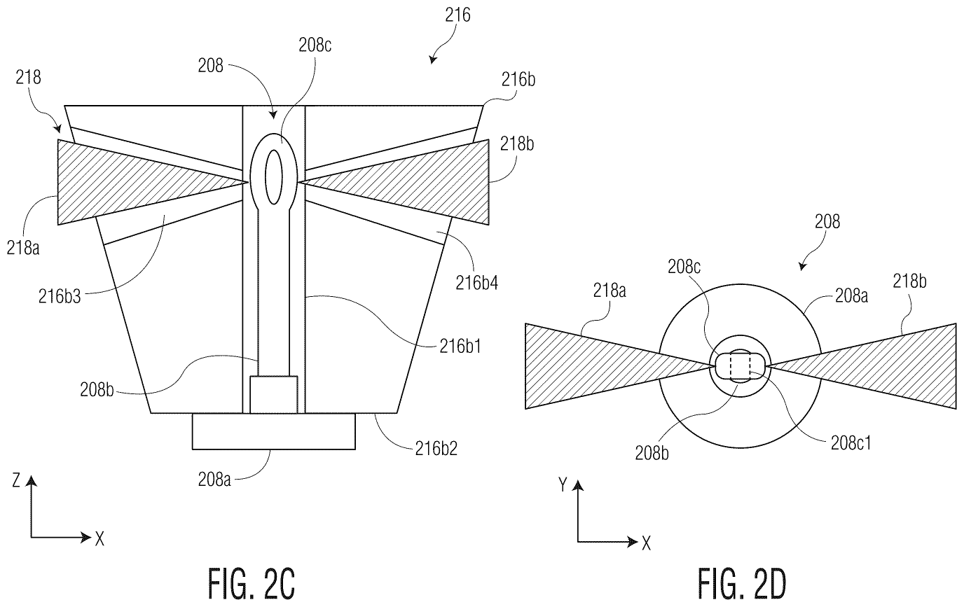

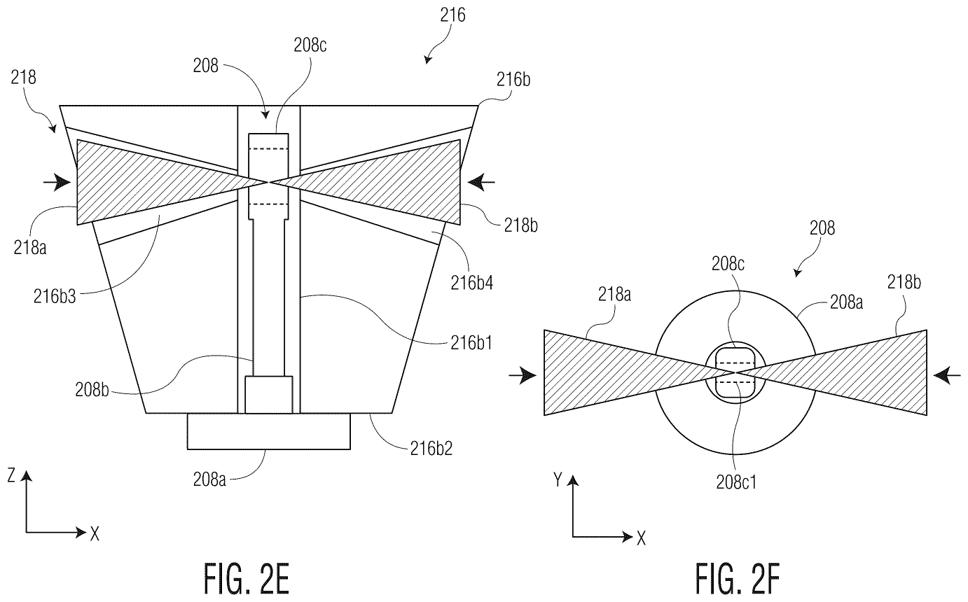

Referring now to FIGS. 2A-2F, a sonotrode 216 for ultrasonically welding a conductive pin 208 to a workpiece is illustrated. Sonotrode 216 includes a body portion (e.g., see body portion 116a of FIG. 1) configured to be coupled to ultrasonic converter 112b. The body portion of sonotrode 216 terminates at a tip portion 216b. Tip portion 216b is configured to receive conductive pin 208. For example, tip portion 216b defines an aperture 216b1 for receiving conductive pin 208. Tip portion 216b defines a working surface 216b2 for interacting with a base portion 208 a of conductive pin 208.

Tip portion 216b is illustrated including a lateral aperture 216b3 and a lateral aperture 216b4. Lateral aperture 216b3 and lateral aperture 216b4 are configured such that alignment tools (e.g., orienting needles) of an alignment mechanism can be disposed within lateral aperture 216b3 and lateral aperture 216b4 to align conductive pin 208 within aperture 216b1 of sonotrode 216.

Conductive pin 208 is illustrated disposed within sonotrode 216 (e.g., using vacuum of a vacuum source), such that a surface of base portion 208a is contacting working surface 216b2 of sonotrode 216. Conductive pin 208 includes base portion 208a coupled to an elongate portion 208b. Conductive pin 208 defines hole 208c1 at a location along its length. In the example shown in FIG. 2A, hole 208c1 is defined by an upper tip 208c of conductive pin 208.

Referring now to FIG. 2B, a top view of conductive pin 208 is illustrated (with sonotrode 216 not illustrated for clarity).

Referring now to FIGS. 2C-2D, an alignment mechanism 218 of sonotrode 216 is illustrated. Alignment mechanism 218 is configured to align conductive pin 208 within aperture 216b1 through engagement with hole 208c1 (and/or tip portion 208c). Alignment mechanism 218 includes an alignment tool 218a and an alignment tool 218b for aligning conductive pin 208. Alignment tool 218a is disposed within lateral aperture 216b3 of sonotrode 216. Alignment tool 218b is disposed within lateral aperture 216b4 of sonotrode 216.

As illustrated, alignment tool 218a and alignment tool 218b are brought into contact with tip portion 208c of conductive pin 208. In certain embodiments, alignment tool 218a and alignment tool 218b are configured to be provided with ultrasonic energy (e.g., USG from ultrasonic converter 112b) during a pin alignment operation. In certain embodiments, alignment tool 218a and alignment tool 218b are configured to vibrate (e.g., using a piezostack actuator) during a pin alignment operation.

Referring now to FIGS. 2E-2F, alignment mechanism 218 of sonotrode 216 is illustrated pushing through hole 208c1 of conductive pin 208, thereby rotating (e.g., ˜90°), orienting, and aligning conductive pin 208. Accordingly, sonotrode 216 and/or alignment mechanism 218 has illustrated orienting conductive pin 208 in a desired (e.g., predetermined) orientation.

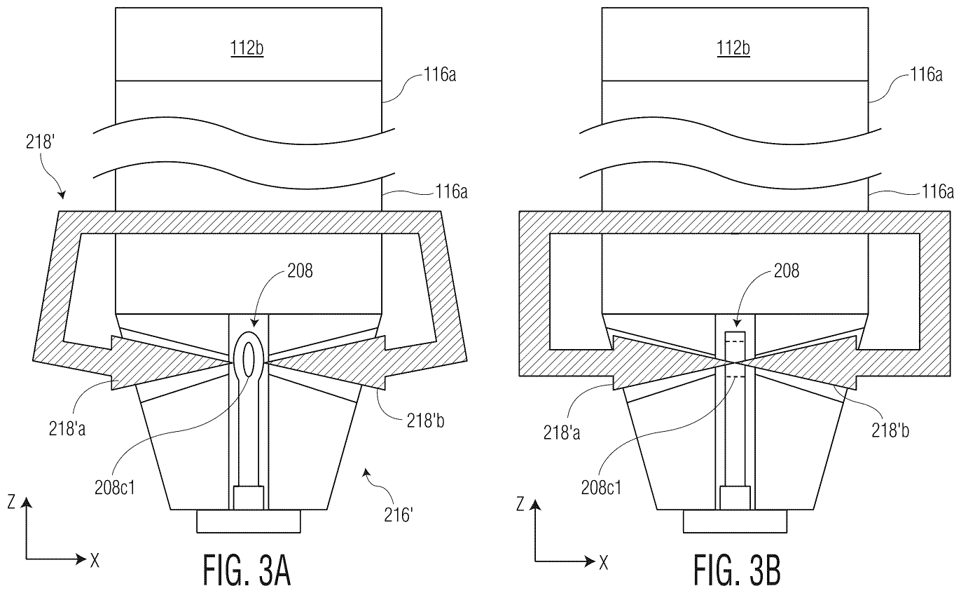

Referring now to FIGS. 3A-3B, a sonotrode 216′ is illustrated. Sonotrode 216′ is substantially the same as sonotrode 216, except an alignment mechanism 218′ is included in lieu of alignment mechanism 218 of sonotrode 216. Repeated reference numerals are omitted, and certain reference numerals related to FIG. 1 have been added, for clarity. Alignment mechanism 218′ includes a spring-based alignment tool 218′a and a spring-based alignment tool 218′b (e.g., using a leafspring). Referring specifically to FIG. 3A, spring-based alignment tool 218′a and spring-based alignment tool 218′b are compressed/bent when conductive pin 208 is not aligned. Referring specifically to FIG. 3B, spring-based alignment tool 218′a and spring-based alignment tool 218′b are uncompressed/straightened when conductive pin 208 is rotated, aligned, and oriented.

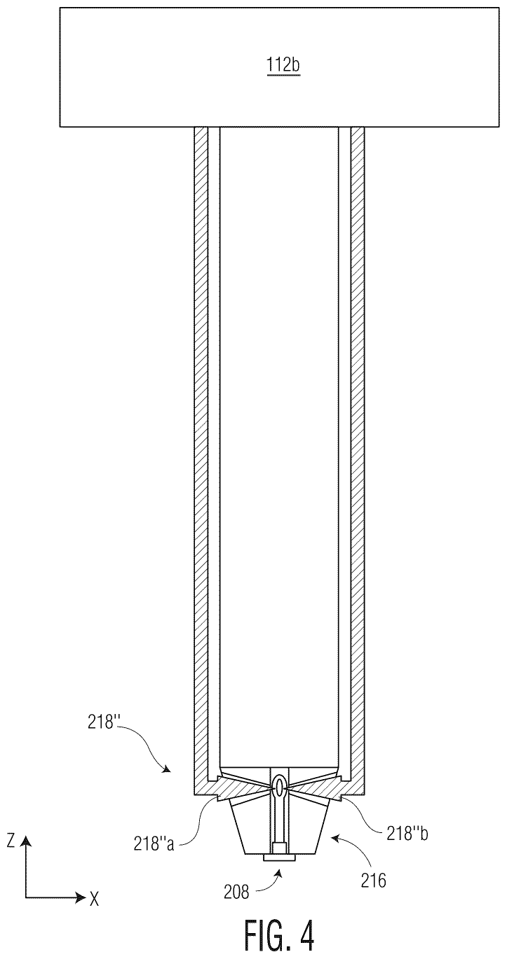

Referring now to FIG. 4, sonotrode 216 is illustrated being used in connection with an alignment mechanism 218″. Alignment mechanism 218″ is substantially the same as alignment mechanism 218′ of FIGS. 3A-3B, except alignment mechanism 218′ is not fully supported by the sonotrode; instead, alignment mechanism 218″ (including a spring-based alignment tool 218″a and a spring-based alignment tool 218″b) are supported by ultrasonic converter 112b of weld head assembly 112. Thus, it is clear that alignment mechanisms within the scope of the invention may be supported by any part of the weld head assembly 112. Repeated reference numerals are omitted, and certain reference numerals related to FIG. 1 have been added, for clarity.

Additional exemplary aspects (and uses) of the alignment tools (e.g., orienting needles) illustrated and described in connection with FIGS. 2A-2F, 3A-3B, and 4 may be described as follows. After a conductive pin is introduced into the sonotrode (e.g., by vacuum), the alignment tools (e.g., orienting needles) may be pressed against a portion of the conductive pin defining the hole (the “fisheye”). Energy (e.g., ultrasonic energy, vibration, etc.) may be applied to the sonotrode to properly orient the conductive pin with the alignment tools (e.g., orienting needles). After the conductive pin is properly oriented, the conductive pin is welded to a workpiece. The sonotrode may then be lifted (e.g., after releasing the alignment tools) to retrieve another conductive pin. The alignment tools may be released before or after the ultrasonic welding of the conductive pin to the workpiece. The alignment tools (e.g., orienting needles) may not touch the sonotrode during the operation, and may have rounded tips to assist in orienting a conductive pin and to avoid excess wear.

The alignment tools (e.g., orienting needles) may be actuated by electric, pneumatic, air, piezo, solenoid, electric motor or any other device sufficient for the process. The alignment tools (e.g., orienting needles) may be formed of a hard and durable engineering material, metal, ceramic or combination, such as tungsten carbide. The alignment tools (e.g., orienting needles) may have a durable coating, or a special tip section made out of separate material than the remainder of the alignment tool.

Although the drawings illustrate two distinct alignment tools in each of FIGS. 2A-2F, 3A-3B, and 4, the invention is not limited thereto. A single alignment tool, or more than two alignment tools, are contemplated.

In certain embodiments, ultrasonic energy may be provided to the alignment tools (e.g., alignment tool 218a, alignment tool 218b, alignment tool 218′a, alignment tool 218′b, alignment tool 218″a, alignment tool 218″b) of the alignment mechanisms (e.g., alignment mechanism 218, alignment mechanism 218′, alignment mechanism 218″) using ultrasonic converter 112b to help orient/rotate conductive pin 208 (e.g., to help interconnection of the alignment tool and hole 208c1 of upper tip 208c of conductive pin 208, to help overcome friction due to misalignment, etc.).

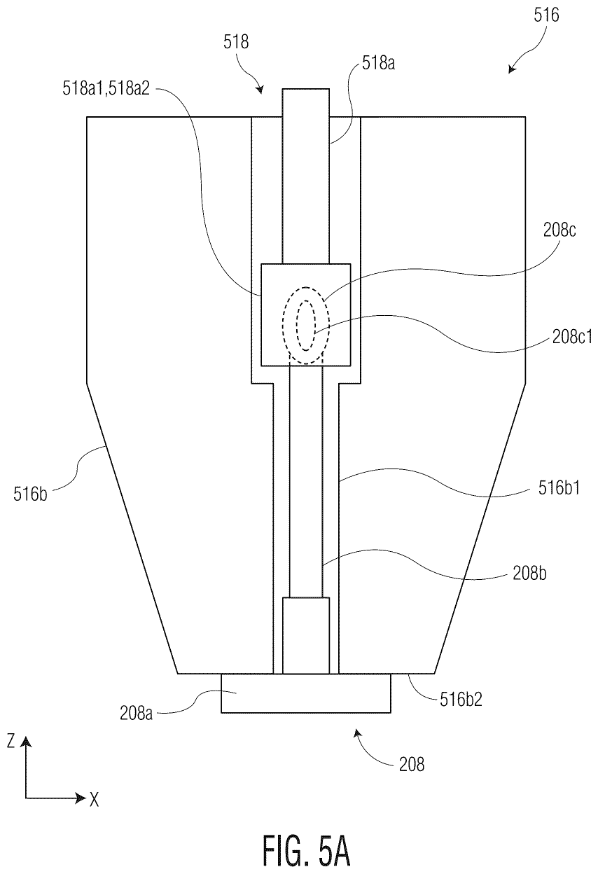

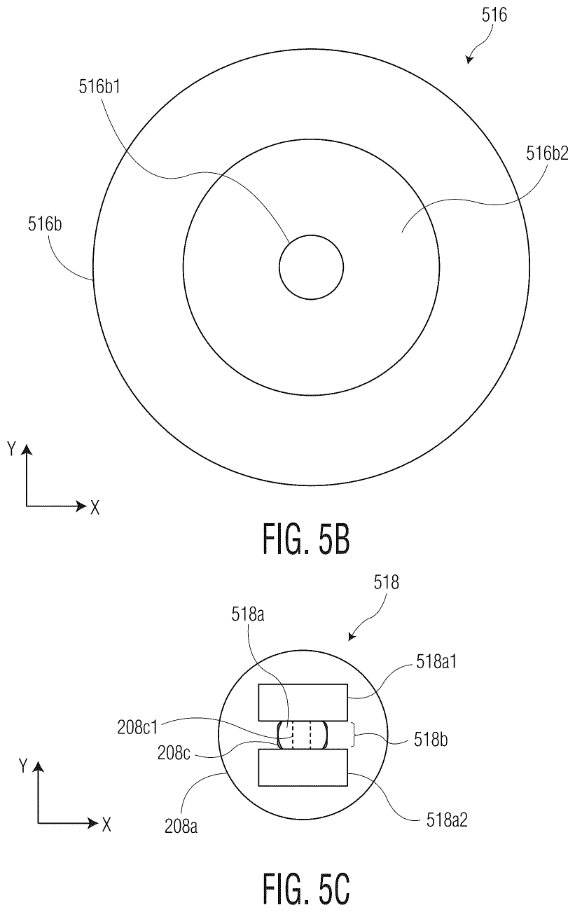

Referring now to FIG. 5A, a sonotrode 516 for ultrasonically welding conductive pin 208 to a workpiece is illustrated. Sonotrode 516 includes a body portion (e.g., see body portion 116a of FIG. 1) configured to be coupled to ultrasonic converter 112b. The body portion of sonotrode 516 terminates at a tip portion 516b. Tip portion 516b is configured to receive conductive pin 208. For example, tip portion 516b defines an aperture 516b1 for receiving conductive pin 208. Aperture 516b1 may include more than one diameter along the length of sonotrode 516 to accommodate different elements (e.g., conductive pin 208, an alignment mechanism, an alignment tool, etc.). In the illustrated embodiment, aperture 516b1 includes: a first diameter configured for receiving a conductive pin (e.g., conductive pin 208); and a second diameter configured for receiving a portion of an alignment mechanism (e.g., alignment tool 518a). Tip portion 516b defines a working surface 516b2 for interacting with base portion 208a of conductive pin 208.

Sonotrode 516 includes an alignment mechanism 518. Alignment mechanism 518 includes an alignment tool 518a for aligning conductive pin 208. Alignment tool 518a is disposed within aperture 516b1 of sonotrode 516. Alignment tool 518a defines an alignment aperture 518b (e.g., a gap, a space, an opening, etc. as illustrated in FIG. 5C) configured to receive upper tip 208c of conductive pin 208.

Referring now to FIG. 5B, a bottom view of sonotrode 516 is illustrated. Referring now to FIG. 5C, a top view of conductive pin 208 interacting with a portion of alignment tool 518a is illustrated.

When conductive pin 208 is provided to sonotrode 516 (e.g., sonotrode 516 picks up conductive pin 208 using provided by a vacuum source), alignment tool 518a interacts with an upper portion (e.g., upper tip 208c) of conductive pin 208 such that conductive pin 208 is oriented in a predetermined configuration. In the illustrated embodiment, alignment tool 518a includes a first flanged portion 518a1 and a second flanged portion 518a2. First flanged portion 518a1 and second flanged portion 518a2 are disposed on opposite sides of conductive pin 208 in order to orient conductive pin 208 (e.g., at least a portion of conductive pin 208, such as upper tip 208c, may be described as “sandwiched” between first flanged portion 518a1 and second flanged portion 518a2). In certain embodiments, ultrasonic energy may be provided to alignment tool 518a using ultrasonic converter 112b to help orient/rotate conductive pin 208 (e.g., to help interconnection of alignment tool 518a and upper tip 208c of conductive pin 208, to help overcome friction due to misalignment, etc.).

Certain embodiments of the invention relate to mating features of a tip portion of a sonotrode interacting with a corresponding mating feature of a base portion of a conductive pin. As used herein, “mating feature” refers to a shape, structure, or feature configured to orient a conductive pin in a predetermined configuration. For example, the predetermined configuration might relate to arranging the “hole” of a fisheye pin such that it faces (e.g., is angled in) a predetermined direction. In another example, the predetermined configuration might relate to arranging an “L” shaped pin such that it faces (e.g., is angled in) a predetermined direction.

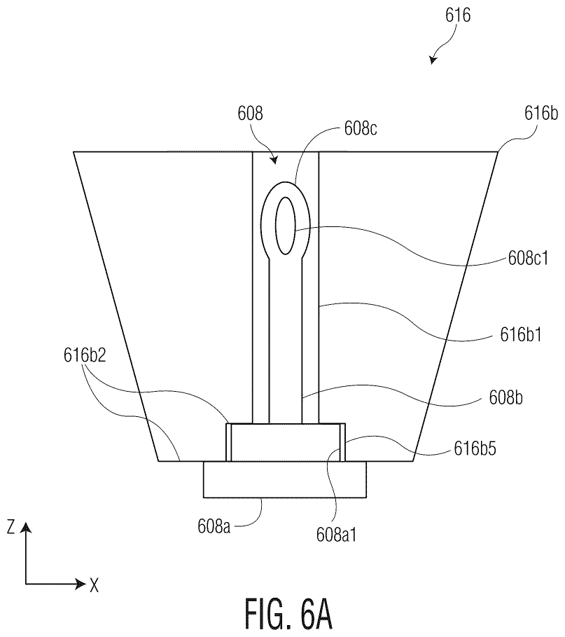

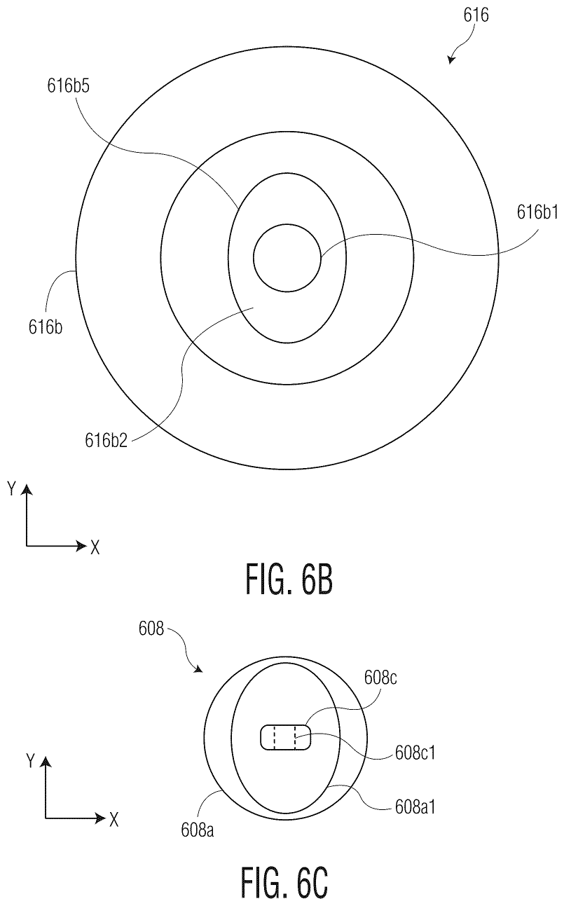

Although various embodiments illustrated in FIGS. 6A-6C, 7A-7C, 8A-8E, 9A-9E, and/or 10A-10C illustrate flat or planar mating features (e.g., including chamfered mating features), it should be understood that the mating features may include curved surfaces (e.g., a concave dome shape, a semi ellipsoidal shape, a groove shape, a tapered shape, etc.) to help align a mating feature of a tip portion of a sonotrode with a corresponding mating feature of a base portion of a conductive pin. It should be understood that certain mating features described herein may be used in connection with vibrational energy (e.g., ultrasonic energy), and vacuum, such that misalignment between a mating feature (e.g., of a tip portion of a sonotrode) and a corresponding mating feature (e.g., of a base portion of a conductive pin) can be mitigated and ameliorated prior to ultrasonically welding the conductive pin to a workpiece.

Referring now to FIG. 6A, a sonotrode 616 for ultrasonically welding a conductive pin 608 to a workpiece is illustrated. Sonotrode 616 includes a body portion (e.g., see body portion 116a of FIG. 1) configured to be coupled to ultrasonic converter 112b. The body portion of sonotrode 616 terminates at a tip portion 616b. Tip portion 616b is configured to receive a conductive pin 608. For example, tip portion 616b defines an aperture 616b1 for receiving conductive pin 608. Tip portion 616b defines a working surface 616b2 for interacting with a base portion 608a of conductive pin 608. Tip portion 616b defines a mating feature 616b5 configured to mate with a corresponding mating feature 608a1 of base portion 608a.

Conductive pin 608 is illustrated disposed within sonotrode 616 (e.g., using vacuum of a vacuum source), such that a surface of base portion 608a is contacting working surface 616b2 of sonotrode 616. Conductive pin 608 includes base portion 608a coupled to an elongate portion 608b. Conductive pin 608 includes an upper tip 608c defining a hole 608c1. Conductive pin 608 is oriented in a predetermined configuration by mating of mating feature 616b5 of sonotrode 616 with the corresponding mating feature 608a1 of base portion 608a. Although mating feature 616b5 of sonotrode 616 is illustrated with a slight gap (e.g., not flush) with respect to mating feature 608a1 of base portion 608a, such a gap is provided for illustrative purposes only; it is understood that mating feature 616b5 and mating feature 608a1 are sufficiently close along their respective perimeters to provide proper alignment of conductive pin 608.

Referring now to FIG. 6B, a bottom view of sonotrode 616 is illustrated. Referring now to FIG. 6C, a top view of conductive pin 608 is illustrated. In the illustrated embodiments, mating feature 616b5 and mating feature 608a1 are substantially oval in shape and of similar (although different) size.

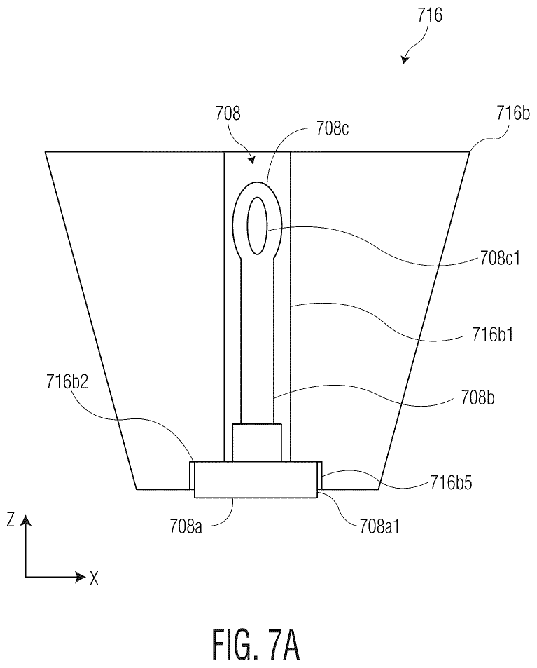

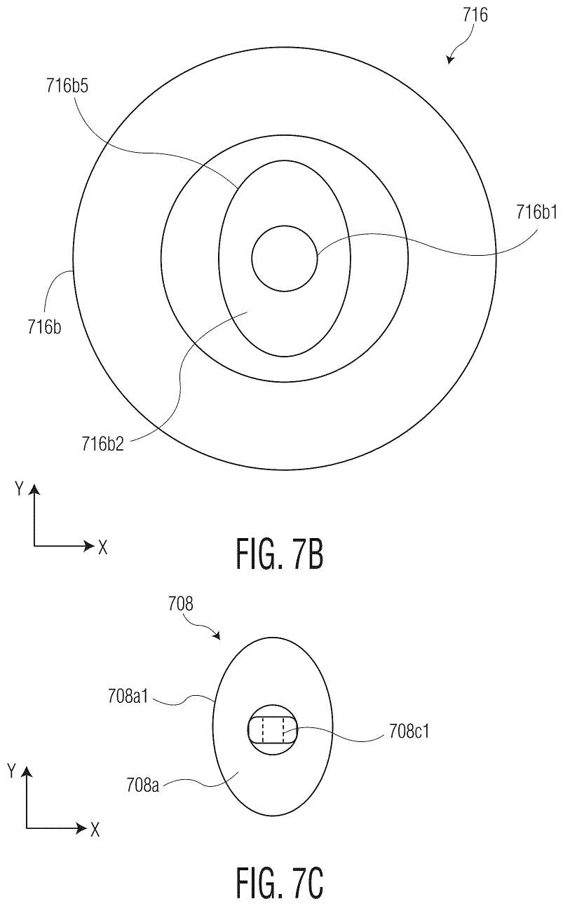

Referring now to FIG. 7A, a sonotrode 716 for ultrasonically welding a conductive pin 708 to a workpiece is illustrated. Sonotrode 716 includes a body portion (e.g., see body portion 116a of FIG. 1) configured to be coupled to ultrasonic converter 112b. The body portion of sonotrode 716 terminates at a tip portion 716b. Tip portion 716b is configured to receive conductive pin 708. For example, tip portion 716b defines an aperture 716b1 for receiving conductive pin 708. Tip portion 716b defines a working surface 716b2 for interacting with a base portion 708a of conductive pin 708. Tip portion 716b defines a mating feature 716b5 configured to mate with a corresponding mating feature 708a1 of base portion 708a of conductive pin 708.

Conductive pin 708 is illustrated disposed within sonotrode 716 (e.g., using vacuum of a vacuum source), such that a surface of base portion 708a is contacting working surface 716b2 of sonotrode 716. Conductive pin 708 includes base portion 708a coupled to an elongate portion 708b. Conductive pin 708 includes an upper tip 708c defining a hole 708c1. Conductive pin 708 is oriented in a predetermined configuration by mating of mating feature 716b5 of sonotrode 716 with the corresponding mating feature 708a1 of base portion 708a. Although mating feature 716b5 of sonotrode 716 is illustrated with a slight gap (e.g., not flush) with respect to mating feature 708a1 of base portion 708a, such a gap is provided for illustrative purposes only; it is understood that mating feature 716b5 and mating feature 708a1 are sufficiently close along their respective perimeters to provide proper alignment of conductive pin 708.

Referring now to FIG. 7B, a bottom view of sonotrode 716 is illustrated. Referring now to FIG. 7C, a top view of conductive pin 708 is illustrated. In the illustrated embodiments, mating feature 716b5 and mating feature 708a1 are substantially oval in shape and of similar (although different) size. The primary difference between the embodiment illustrated in FIGS. 7A-7C as compared to that of FIGS. 6A-6C is that the mating feature of the conductive pin is the bottommost portion of the conductive pin (i.e., FIGS. 7A-7C) as compared to a feature that is not the bottommost feature (i.e., see mating portion 608a1 on a portion of conductive pin 608 which is not the bottommost feature of FIGS. 6A-6C).

Although conductive pin 208, conductive pin 608, and conductive pin 708 may be understood as an assembly of various materials (e.g., a rivet, a conductive sleeve, an elongate pin body, etc.) where the respective elongate portion is generally cylindrical, the invention is not so limited. For example, a conductive pin may be a unitary piece of material (e.g., a bent piece of conductive material) where a cross section of such a conductive pin may be generally rectangular (e.g., see conductive pin 808, conductive pin 908, conductive pin 1008, etc.).

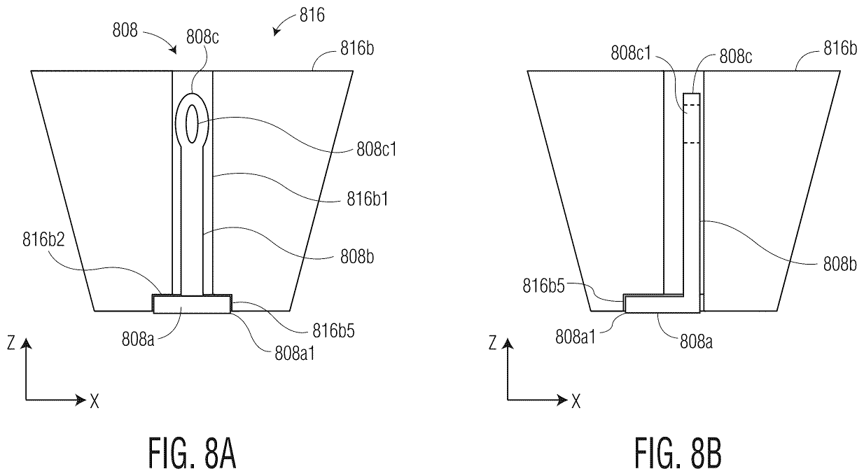

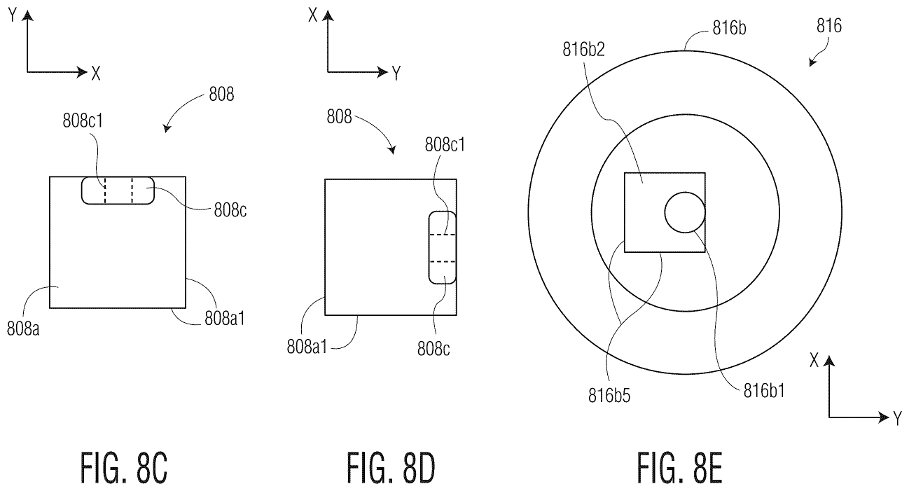

Referring now to FIGS. 8A-8B, a sonotrode 816 for ultrasonically welding a conductive pin 808 (e.g., an “L” shaped conductive pin) to a workpiece is illustrated. Sonotrode 816 includes a body portion (e.g., see body portion 116a of FIG. 1) configured to be coupled to ultrasonic converter 112b. The body portion of sonotrode 816 terminates at a tip portion 816b. Tip portion 816b is configured to receive a conductive pin 808. For example, tip portion 816b defines an aperture 816b1 for receiving conductive pin 808. Tip portion 816b defines a working surface 816b2 for interacting with a base portion 808a of conductive pin 808. Tip portion 816b defines a mating feature 816b5 configured to mate with a corresponding mating feature 808a1 of base portion 808a of conductive pin 808.

Conductive pin 808 is illustrated disposed within sonotrode 816 (e.g., using vacuum of a vacuum source), such that a surface of base portion 808a is contacting working surface 816b2 of sonotrode 816. Conductive pin 808 includes base portion 808a coupled to an elongate portion 808b. Conductive pin 808 includes an upper tip 808c defining a hole 808c1. Conductive pin 808 is oriented in a predetermined configuration by mating of mating feature 816b5 of sonotrode 816 with the corresponding mating feature 808a1 of base portion 808a.

Referring now to FIGS. 8C-8D, top views of conductive pin 808 are illustrated (with the size arbitrarily expanded for clarity). Referring now to FIG. 8E, a bottom view of sonotrode 816 is illustrated.

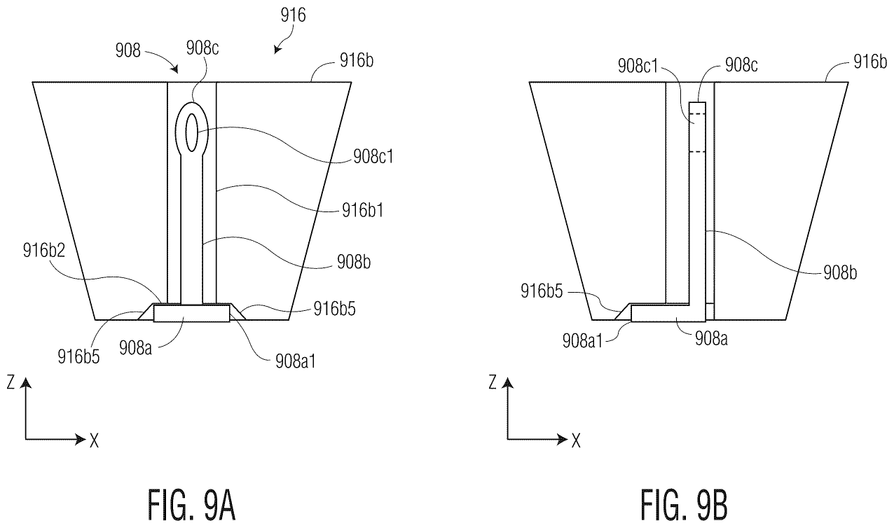

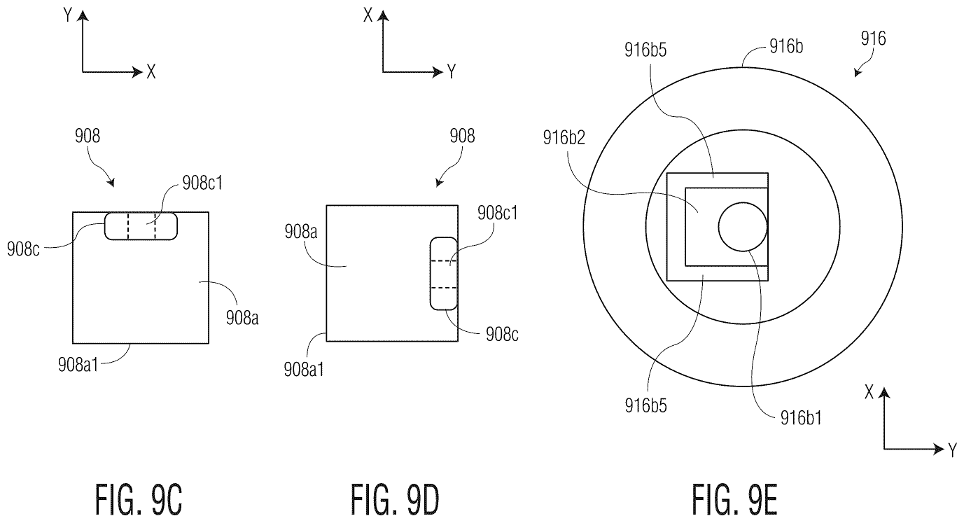

Referring now to FIGS. 9A-9B, a sonotrode 916 for ultrasonically welding a conductive pin 908 (e.g., an “L” shaped conductive pin) to a workpiece is illustrated. Sonotrode 916 includes a body portion (e.g., see body portion 116a of FIG. 1) configured to be coupled to ultrasonic converter 112b. The body portion of sonotrode 916 terminates at a tip portion 916b. Tip portion 916b is configured to receive conductive pin 908. For example, tip portion 916b defines an aperture 916b1 for receiving conductive pin 908. Tip portion 916b defines a working surface 916b2 for interacting with a base portion 908a of conductive pin 908. Tip portion 916b defines a mating feature 916b5 (e.g., a chamfered portion, a rounded portion, a fillet portion, etc.) configured to mate with a corresponding mating feature 908a1 of base portion 908a of conductive pin 908. It should be understood that although mating feature 916b5 is illustrated as including a single chamfer size, a combination of chamfer sizes may be used (e.g., a large or shallow chamfer adjacent a smaller or steep chamfer in order to help orient conductive pin 908 when used with a vacuum). Mating feature 916b5 (defined by tip portion 916b) includes a chamfered portion configured to guide conductive pin 908 to an aligned position with respect to sonotrode 916. For example, when a vacuum is pulled through aperture 916b1, a portion of conductive pin 908 (e.g., a corresponding mating feature 908a1 of base portion 908a, an edge of base portion 908a) may be pulled against the chamfered portion to orient and/or position conductive pin 908 in a desired location within aperture 916b1.

Conductive pin 908 is illustrated disposed within sonotrode 916 (e.g., using vacuum of a vacuum source), such that a surface of base portion 908a is contacting working surface 916b2 of sonotrode 916. Conductive pin 908 includes base portion 908a coupled to an elongate portion 908b. Conductive pin 908 includes an upper tip 908c. Conductive pin 908 is oriented in a predetermined configuration by mating of mating feature 916b5 of sonotrode 916 with the corresponding mating feature 908a1 of base portion 908a.

Referring now to FIGS. 9C-9D, a top view of conductive pin 908 is illustrated (with the size arbitrarily expanded for clarity). Referring now to FIG. 9E, a bottom view of sonotrode 916 is illustrated. The embodiment illustrated in FIGS. 9A-9E may be particularly suitable for linear ultrasonic welding.

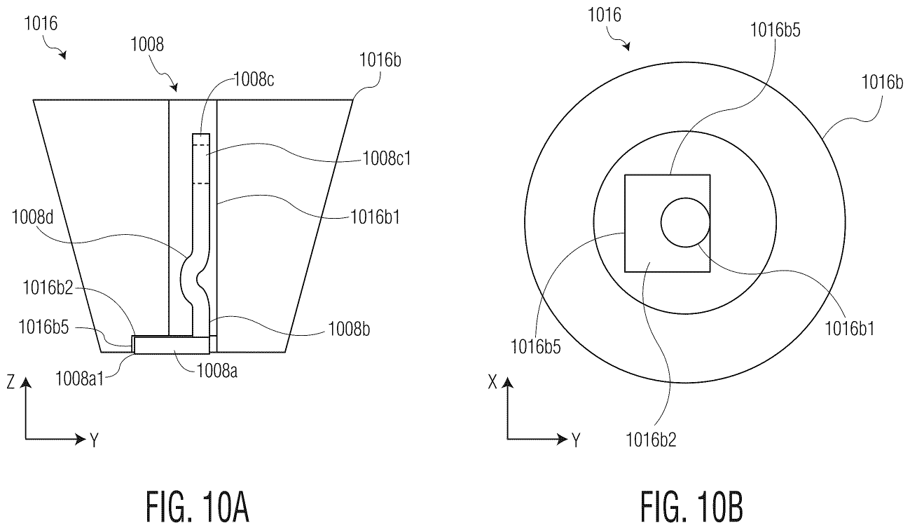

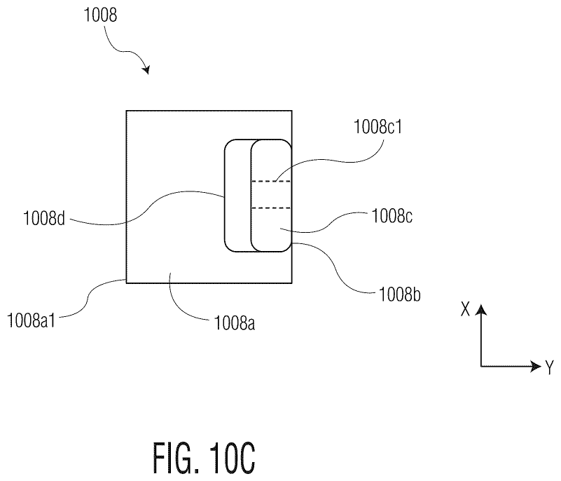

Referring now to FIG. 10A, a sonotrode 1016 for ultrasonically welding a conductive pin 1008 to a workpiece is illustrated. Sonotrode 1016 includes a body portion (e.g., see body portion 116a of FIG. 1) configured to be coupled to ultrasonic converter 112b. The body portion of sonotrode 1016 terminates at a tip portion 1016b. Tip portion 1016b is configured to receive conductive pin 1008. For example, tip portion 1016b defines an aperture 1016b1 for receiving conductive pin 1008. Tip portion 1016b defines a working surface 1016b2 for interacting with a base portion 1008a of conductive pin 1008. Tip portion 1016b defines a mating feature 1016b5 configured to mate with a corresponding mating feature 1008a1 of base portion 1008a of conductive pin 1008.

Conductive pin 1008 is illustrated disposed within sonotrode 1016 (e.g., using vacuum of a vacuum source), such that a surface of base portion 1008a is contacting working surface 1016b2 of sonotrode 1016. Conductive pin 1008 includes base portion 1008a coupled to an elongate portion 1008b. Conductive pin 1008 includes an upper tip 1008c defining a hole 1008c1. Conductive pin 1008 includes a stress relieving portion 1008d. Conductive pin 1008 is oriented in a predetermined configuration by mating of mating feature 1016b5 of sonotrode 1016 with the corresponding mating feature 1008a1 of base portion 1008a.

Referring now to FIG. 10B, a bottom view of sonotrode 1016 is illustrated. Referring now to FIG. 10C, a top view of conductive pin 1008 is illustrated (with the size arbitrarily expanded for clarity).

As will be appreciated by those skilled in the art, the shapes of the respective mating features of the sonotrode, and base portions, are simplified in the drawings herein (e.g., in FIGS. 6A-6C, 7A-7C, 8A-8E, 9A-9E, and 10A-10C). It will be appreciated that in order for the respective mating features to perform the function of orienting the conductive pin in the desired predetermined configuration, the mating features may have curvature and other features not shown herein.

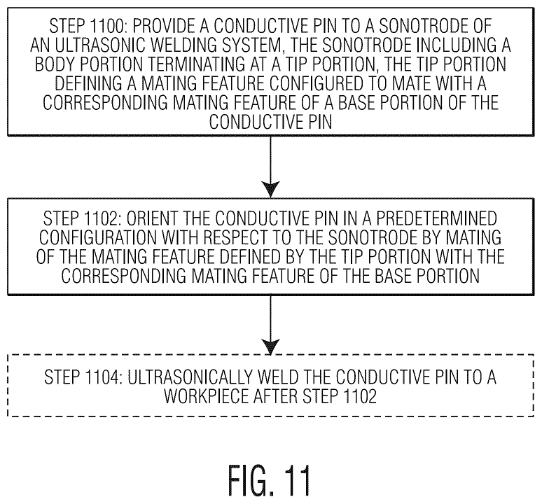

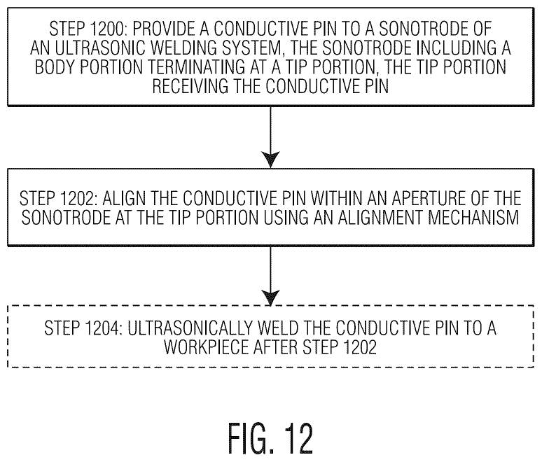

FIGS. 11-12 are flow diagrams illustrating various methods of operating an ultrasonic welding system. As is understood by those skilled in the art, certain steps included in the flow diagram may be omitted; certain additional steps may be added; and the order of the steps may be altered from the order illustrated—all within the scope of the invention.

Referring now to FIG. 11, a method of operating an ultrasonic welding system (e.g., ultrasonic welding system 100) is illustrated. At Step 1100, a conductive pin (e.g., conductive pin 608, conductive pin 708, conductive pin 808, conductive pin 908, conductive pin 1008) is provided to a sonotrode (e.g., sonotrode 616, sonotrode 716, sonotrode 816, sonotrode 916, sonotrode 1016) of the ultrasonic welding system. The sonotrode includes a body portion (e.g., body portion 116a) terminating at a tip portion (e.g., tip portion 116b, tip portion 616b, tip portion 716b, tip portion 816b, tip portion 916b, tip portion 1016b). The tip portion defines a mating feature (e.g., mating feature 616b5, mating feature 716b5, mating feature 816b5, mating feature 916b5, mating feature 1016b5) configured to mate with a corresponding mating feature (e.g., mating feature 608a1, mating feature 708a1, mating feature 808a1, mating feature 908a1, mating feature 1008a1) of a base portion (e.g., base portion 608a, base portion 708a, base portion 808a, base portion 908a, base portion 1008a) of the conductive pin. At Step 1102, the conductive pin is oriented in a predetermined configuration with respect to the sonotrode by mating of the mating feature with the corresponding feature of the base portion. At Step 1104, the conductive pin is ultrasonically welded (e.g., using torsional motion, linear motion, etc.) to a workpiece after Step 1102.

Referring now to FIG. 12, a method of operating an ultrasonic welding system is illustrated. At Step 1200, a conductive pin (e.g., conductive pin 208) is provided to a sonotrode (e.g., sonotrode 116, sonotrode 216, sonotrode 216′, sonotrode 516) of the ultrasonic welding system. The sonotrode includes a body portion (e.g., body portion 116b) terminating at a tip portion (e.g., tip portion 216b, tip portion 516b). The tip portion is receiving the conductive pin. At Step 1202, the conductive pin is aligned within an aperture of the sonotrode at the tip portion using an alignment mechanism (e.g., alignment mechanism 218, alignment mechanism 218′, alignment mechanism 218″, alignment mechanism 518). At Step 1204, the conductive pin is ultrasonically welded (e.g., using torsional motion, linear motion, etc.) to a workpiece after Step 1202.

Although the invention is illustrated and described herein with reference to specific embodiments, the invention is not intended to be limited to the details shown. Rather, various modifications may be made in the details within the scope and range of equivalents of the claims and without departing from the invention.

1. A sonotrode for ultrasonically welding a conductive pin to a workpiece, the sonotrode comprising:
a body portion configured to be coupled to an ultrasonic converter,
the body portion terminating at a tip portion, the tip portion defining a mating feature configured to mate with a corresponding mating feature of a base portion of the conductive pin, wherein the conductive pin is oriented in a predetermined configuration by mating of the mating feature defined by the tip portion with the corresponding mating feature of the base portion.

2. The sonotrode of claim 1 wherein the mating feature defined by the tip portion includes an aperture configured to mate with a shape of the corresponding mating feature of the base portion.

3. The sonotrode of claim 1 wherein the conductive pin defines a hole at a location along its length, the predetermined configuration being related to an orientation of the hole.

4. The sonotrode of claim 1 wherein the conductive pin is an “L” shaped conductive pin, the predetermined configuration being related to an orientation of the “L” shaped conductive pin.

5. The sonotrode of claim 1 wherein the conductive pin is a power terminal configured for ultrasonic welding in a power module.

6. The sonotrode of claim 1 wherein the sonotrode is configured to weld the conductive pin to a workpiece using torsional motion.

7. The sonotrode of claim 1 wherein the sonotrode is configured to weld the conductive pin to a workpiece using linear motion.

8. The sonotrode of claim 1 wherein the mating feature defined by the tip portion includes a chamfered portion configured to guide the conductive pin to an aligned position with respect to the sonotrode.

9. An ultrasonic welding system including:
a support structure configured for supporting a workpiece;
a weld head assembly including an ultrasonic converter; and
a sonotrode carried by the ultrasonic converter, the sonotrode including a tip portion, the tip portion defining a mating feature configured to mate with a corresponding mating feature of a base portion of the conductive pin, wherein the conductive pin is oriented in a predetermined configuration by mating of the mating feature with the corresponding feature of the base portion.

10. (canceled)

11. (canceled)

12. (canceled)

13. (canceled)

14. (canceled)

15. (canceled)

16. (canceled)

17. (canceled)

18. (canceled)

19. A method of operating an ultrasonic welding system comprising the steps of:
(a) providing a conductive pin to a sonotrode of the ultrasonic welding system, the sonotrode including a body portion terminating at a tip portion, the tip portion defining a mating feature configured to mate with a corresponding mating feature of a base portion of the conductive pin; and
(b) orienting the conductive pin in a predetermined configuration with respect to the sonotrode by mating of the mating feature defined by the tip portion with the corresponding mating feature of the base portion.

20. The method of claim 19 wherein step (a) includes picking up the conductive pin using the sonotrode.

21. The method of claim 20 wherein the sonotrode picks up the conductive pin using a vacuum source.

22. The method of claim 19 wherein step (b) includes using a vacuum source coupled to the sonotrode, wherein the vacuum source assists in orienting the conductive pin in the predetermined configuration.

23. The method of claim 19 further comprising a step of (c) ultrasonically welding the conductive pin to a workpiece after step (b).

24. The method of claim 23 wherein step (c) includes using torsional welding for ultrasonically welding the conductive pin to the workpiece.

25. The method of claim 23 wherein step (c) includes using linear welding for ultrasonically welding the conductive pin to the workpiece.

26. The method of claim 19 wherein the mating feature includes an aperture configured to mate with a shape of the corresponding feature of the base portion.

27. The method of claim 19 wherein the conductive pin defines a hole along its length, the predetermined configuration being related to an orientation of the hole.

28. The method of claim 19 wherein the conductive pin is an “L” shaped conductive pin, the predetermined configuration being related to an orientation of the “L” shaped conductive pin.

29. The method of claim 19 wherein the conductive pin is a power terminal configured for ultrasonic welding in a power module.

30. The method of claim 19 wherein the mating feature defined by the tip portion includes a chamfered portion configured to guide the conductive pin to an aligned position with respect to the sonotrode.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)
